(19) United States
(12) Patent Application Publication
(10) Pub. No.: US 2008/0154576 A1
(43) Pub. Date: Jun. 26, 2008

(54) PROCESSING OF REDUCED-SET USER INPUT TEXT WITH SELECTED ONE OF MULTIPLE VOCABULARIES AND RESOLUTION MODALITIES

(76) Inventors: Jianchao Wu, Sammamish, WA (US); Jenny Huang-Yu Lai, Seattle, WA (US)

Correspondence Address: GLENN PATENT GROUP, 3475 EDISON WAY, SUITE L, MENLO PARK, CA, 94025, US

(21) Appl. No.: 11/614,960

(22) Filed: Dec. 21, 2006

(51) Int. Cl. G06F 17/28

(52) U.S. Cl. 704/2

(57) ABSTRACT

A computer-driven system includes different modes interpreting user entered text according to different corresponding vocabularies. Each mode may additionally include a different modality for ultimately resolving and completing the input. Each mode presents the user with a different interpretation of user entered text, according to the associated vocabulary. Displayed output is limited to one or another of the modes in accordance with user instructions to switch between modes.

### BACKGROUND OF THE INVENTION

1. Field of the Invention

The present invention relates to computer-driven systems for users to enter text into a computer using a reduced-set keyboard. More particularly, the invention provides a computer-driven system that interprets user entered text under different modes. Each mode utilizes a different vocabulary and therefore presents a different output interpretation, and may additionally include a different modality for resolving and completing the user input.

2. Description of the Related Art

Digital devices are widespread today. People commonly use desktop computers, notebook computers, cell phones, personal data assistants (PDAs), and many more such devices. Broadly, each of these is a different implementation of a computer. In these devices, it essential to provide the human user with a suitably reliable, convenient, and expedient method of submitting input to the computer. For this reason, engineers have developed a variety of keyboards, mice, trackballs, joysticks, digitizing surfaces, speech recognition systems, eye gaze tracking systems, and many more.

User entry of logographic, ideographic, or pictographic languages is a special challenge. Unlike English where words are broken down to an alphabet of twenty-six constituent letters, written languages such as Chinese use thousands of different characters. Engineers have approached this challenge by developing solutions employing many different technologies. Some examples include huge character-based keyboards, intricate computer menu systems for use with normal keyboards and mice, stick and button entry tools, handwriting digitizers, and many more. For many, handwriting digitizers are the tool of choice, offering the convenience and natural feel of handwriting input. More recently, software driven approaches have proliferated, offering many different methodologies for entering characters such as Chinese or Japanese.

Many people today are bilingual and sometimes enter text in one language (such as English), but other times enter text in a different language (such as Chinese). Having two different devices can impractical since this can be cumbersome and expensive. However, there are significant technical challenges in providing a computing system that facilitates text entry in two languages. Further, the added challenge of embodying these features in a smooth, intuitive, user interface often asks too much of existing technology.

### SUMMARY OF THE INVENTION

Broadly, a computer-driven system includes different modes interpreting user entered text according to different corresponding vocabularies. Each mode may additionally include a different modality for ultimately resolving and completing the input. Each mode presents the user with a different interpretation of user entered text, according to the associated vocabulary. Displayed output is limited to one or another of these views in accordance with user instructions to switch between modes.

The teachings of this disclosure may be implemented in the form of method, apparatus, logic circuit, storage medium, or a combination of these. This disclosure provides a number of other advantages and benefits, which are apparent from the following description.

### BRIEF DESCRIPTION OF THE DRAWINGS

FIG. 1 is a block diagram of the hardware components and interconnections of a language entry and processing system.

FIGS. 1B-1C illustrate various exemplary contents of a second vocabulary.

FIG. 2 is a block diagram of a digital data processing machine.

FIG. 3 shows an exemplary storage medium.

FIG. 4 is a perspective view of exemplary logic circuitry.

FIG. 5 is a flowchart of an operational sequence for processing reduced-set user input text using multiple vocabularies and resolution modalities.

FIGS. 6A-8D show representative screen shots.

FIG. 9 shows an exemplary tabbed display.

### DETAILED DESCRIPTION

The nature, objectives, and advantages of the invention will become more apparent to those skilled in the art after considering the following detailed description in connection with the accompanying drawings.

### Hardware Components & Interconnections

### Overall Structure

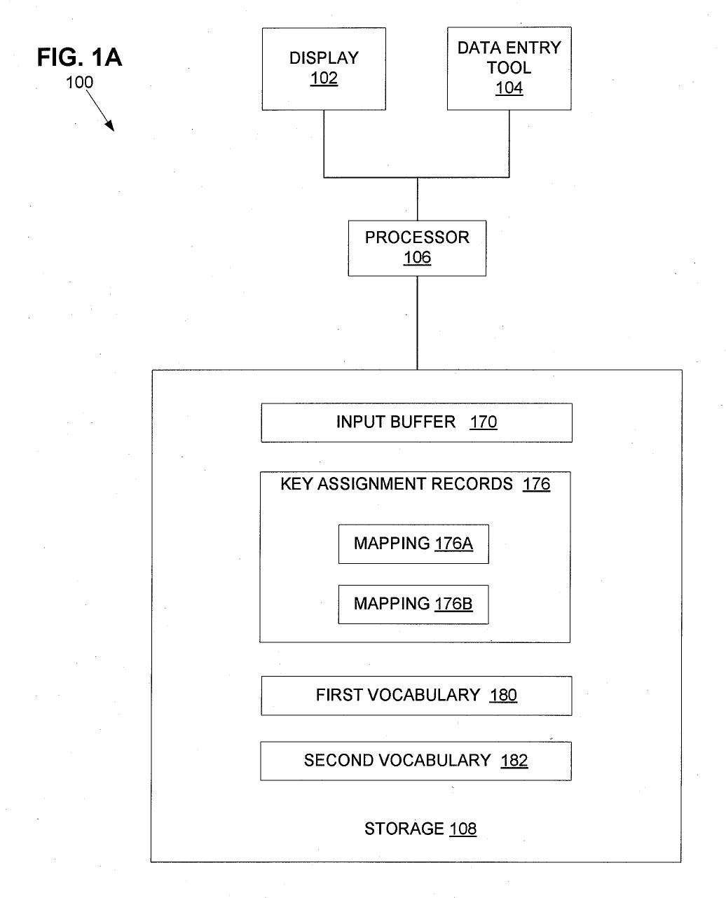

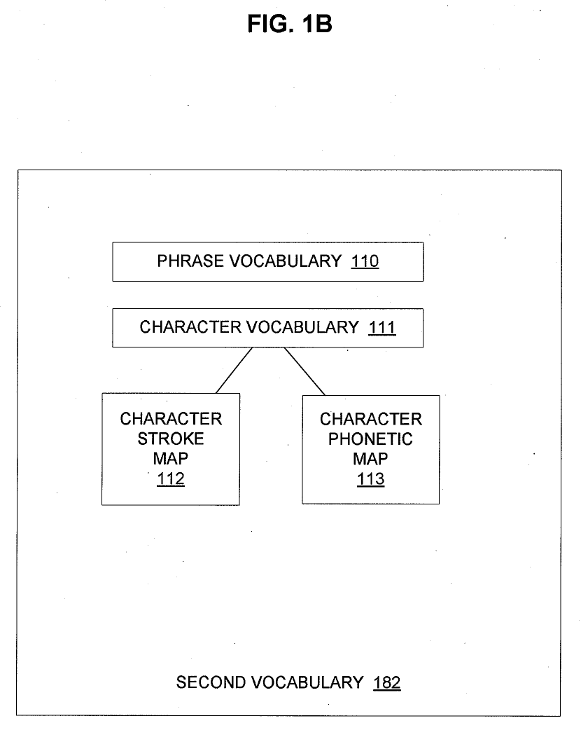

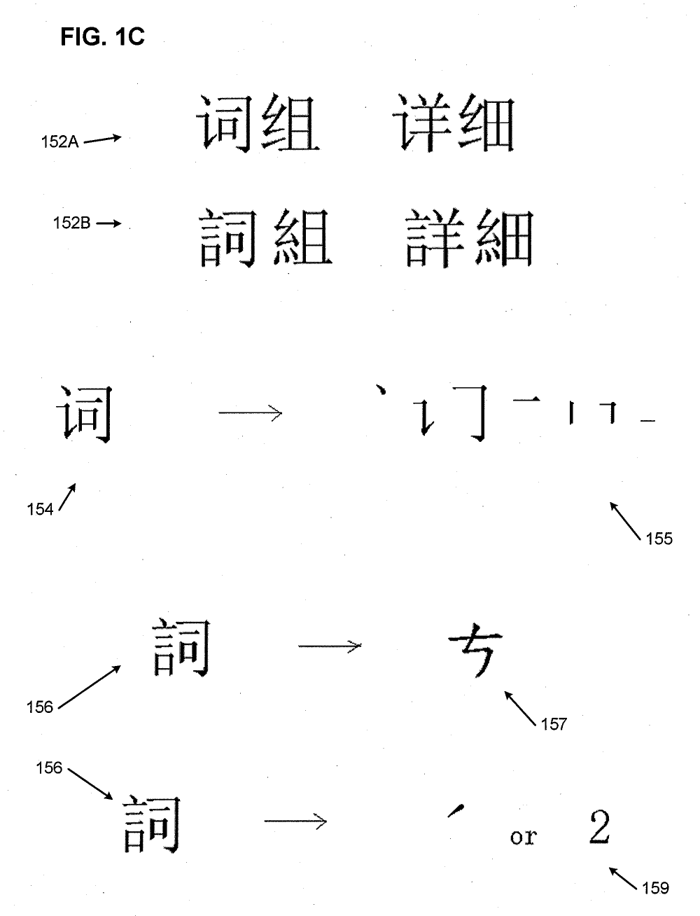

One aspect of the present disclosure concerns a multi-language entry and processing system. This system may be embodied by various hardware components and interconnections, with one example being described by the system 100 of FIG. 1A. With reference to FIG. 1A, the system 100 includes a display 102, data entry tool 104, processor 106, and digital data storage 108.

Display

In one example, the display 102 comprises a relatively small LCD display of a PDA. However, the display 102 may be implemented by another size or configuration of LCD display, CRT, plasma display, or any other device receiving a machine-readable input signal and providing a human-readable visual output.

Data Entry Tool

In one example, the data entry tool 104 comprises a reduced-set keyboard such as a telephone keypad. Alternatively, the data entry tool 104 may be implemented using a full feature QUERTY keyboard. As an alternative, or addition, the data entry tool 104 may include a digitizing component of a PDA. In this respect, the tool 104 may include a digitizing surface such a touch screen, digitizing pad, or virtually any other digitizing surface configured to receive a user's taps or gestures submitted with stylus, pen, pencil, finger, etc.

In addition, or as an alternative, the tool 104 may include a different gesture-input tool such as mouse, roller ball stylus, track ball, light pen, pointing stick, or other mechanism appropriate to the application at hand. The tool 104 may be implemented as a combination of the foregoing devices. In one example, where the tool 104 is implemented as a digitizing surface, the display 102 and tool 104 may be co-located such that the digitizing surface overlies the display 102.

Storage

In one example, the storage 108 comprises micro-sized flash memory of the type used in compact applications such as PDAs. However, the storage 108 may be implemented by a variety of hardware such as magnetic media (such as tape or disk storage), firmware, electronic non-volatile memory (such as ROM or EPROM or flash PROM or EPROM), volatile memory such as RAM, optical storage, and virtually any apparatus for storing machine-readable data in a manner appropriate to the application discussed herein. As to data structure, components in the storage 108 may be implemented by linked lists, lookup tables, relational databases, or any other useful data structure.

As illustrated, the storage 108 includes certain subcomponents, namely, an input buffer 170, first and second vocabularies 180/182, and key assignment records 176.

Input Buffer

The input buffer 170 is used to store user input, and therefore is subject to change. More particularly, the input buffer 170 stores a representation of user-entered keystrokes that have been entered via the data entry tool 104. In one example, where the data entry tool 104 is provided by a telephone keypad, the input buffer 170 stores a record of the telephone keypad keys that have been entered. This record is therefore independent of any downstream interpretation of the user input, which is conducted according to one of the installed vocabularies 180-182 as discussed below.

Key Assignment Records

The key assignment records 176 contain one or more mappings between each key of the data entry tool 104 and zero, one, or multiple symbols used to specify entries of the vocabularies and/or phrasal representations of the vocabularies 180-182. In certain mappings, there may some inherent ambiguity. Some of the keys may be mapped to zero or one symbol in such a mapping, with numerous keys mapped to multiple symbols. Consequently, user-entered keystrokes (under such a mapping) are inherently ambiguous in that they could represent different combinations of intended symbols, depending upon which key representation was intended for each keystroke.

Actually, user-entered keystrokes may be doubly ambiguous because each vocabulary 180-182 may employ a different key mapping. As illustrated, the records 176 include a first key mapping 176a corresponding to the first vocabulary 180, and a second key mapping 176b corresponding to the second vocabulary 182.

For the purpose of this disclosure, a “symbol” includes at least one letter, a syllable, a stroke, a radical, punctuation mark, special feature, or other textual subcomponent in a set of finite number that are used by a language or script to represent the phonetic or written form of human communications.

In the present example, the mapping 176a maps between keys and symbols related to the first vocabulary 180. An example of this appears in Table 1 (below), where the symbols of the first vocabulary are various alphabetic letters that make up words of the first vocabulary. This mapping is applied for user entry of Indo-European language words, as well as entry of Pinyin, romaji, or other phonetic representations of logographic characters.

TABLE 1
Exemplary Mapping 176a

| | | |
|---|---|---|
| 1 | 2 | 3 |
| | abc | def |
| 4 | 5 | 6 |
| ghi | jkl | mno |
| 7 | 8 | 9 |
| pqrs | tuv | wxyz |
| | 0 | |

A second mapping 176b is used where the symbols of the second vocabulary 182 are different than the symbols of the first vocabulary 180. The second mapping 176b maps between keys and symbols used to specify entries of the second vocabulary 182. In the present example, where the first vocabulary is alphabetic, and symbols of the first vocabulary are alphabetic letters, the second mapping 176b maps between the keys and various non-alphanumeric symbols such as strokes or stroke categories that make up Chinese characters. An example of this appears in Table 2 (below). In this example, the keys are not ambiguous, since each key is mapped to one stroke symbol.

TABLE 2
Exemplary Mapping 176b

| Device Key | Stroke Symbol |
|---|---|
| 1 | [symbol] |
| 2 | [symbol] |
| 3 | [symbol] |
| 4 | [symbol] |
| 5 | [symbol] |
| 6 | ? |

Vocabularies

Each of the vocabularies 180-182 comprises a listing of recognized words, phrases, characters, radicals, or other linguistic components of a language, dialect, sociolect, jargon, language subset (such acronyms or proper nouns or another subset, etc. The vocabularies 180-182 may be static, or they may experience changes (directed by the processor 106) in order to implement experiential learning, software updates, vocabulary changes distributed by a manufacturer or other source, etc.

Without any intended limitation, an example is illustrated where the first vocabulary 180 includes a vocabulary built from logographic characters, such as Chinese characters. One example of the first vocabulary is a dictionary of phonetic representations of logographic language characters. Another example is a dictionary of constituent strokes or stroke categories of logographic language characters. In contrast with the first vocabulary, the second vocabulary 182 in the present example includes a listing of words of Indo-European language, and more particularly English.

Continuing with this example, FIG. 1B illustrates further detail of the Chinese second vocabulary 182. The vocabulary 182 includes a phrase vocabulary 110, character vocabulary 111, character stroke map 112, and character phonetic map 113. The system 100 may be configured to implement one or multiple logographic character sets, but for ease of explanation it is described in the context of a single installed character set (182) such as simplified Chinese. For the installed character set, then, the phrase vocabulary 110 contains a listing of logographic phrases. This listing may be taken or derived from various known standards, extracted from corpus, scraped from a search engine, collected from activity of a specific user, etc. The phrase vocabulary 110 may be fixed at manufacture of the system 100, or downloaded upon installation or boot-up or reconfiguration or another suitable time. The phrase vocabulary 110 may undergo self-updating (directed by the processor 106) to gather new phrases from time to time, by consulting users' previous input, the Internet, wireless network, or another source.

In FIG. 1C, refs. 152a-152b show two exemplary Chinese language phrases that may reside in the vocabulary 110. In one example, where simplified Chinese is the installed character set, then the vocabulary 110 would include the characters of 152a.

With reference to FIG. 1B, the character vocabulary 111 is analogous to the phrase vocabulary 110, and contains a listing of recognized logographic characters, for the installed character set. In one example, where simplified Chinese is the installed character set, the vocabulary 111 may contain individual characters such as the character 154 (FIG. 1C).

Optionally, one or both of the vocabularies 110-111 may include data regarding usage frequency of the characters or phrases. This data may be contained in the vocabularies 110-111 or stated elsewhere with appropriate links to the related characters and/or phrases in the vocabularies 110-111. In one embodiment, the usage frequency is stated in a linguistic model (not shown), which broadly indicates general or user-specific usage frequency of characters (and/or phrases) relative to other characters (and/or phrases), or another indication of the probability that the user intends to select that character (or phrase) next. Frequency may be determined by the number of occurrences of the character in written text or in conversation; by the grammar of the surrounding sentence; by its occurrence following the preceding character or characters; by the context in which the system is currently being used, such as typing names into a phonebook application; by its repeated or recent use in the system (the user's own frequency or that of some other source of text); or by any combination thereof. In addition, a character may be prioritized by the probability that a matching component occurs in the character at that point in the entered stroke sequence. In another embodiment, usage frequency is based on the usage of characters or phrases by a particular user, or in a particular context, such as a message or article being composed by the user. In this example, frequently used characters or phrases become more likely characters or phrases.

For some or all of the characters in the vocabulary 111, the character stroke map 112 (FIG. 1B) includes a cross-reference between that character and a listing of its constituent strokes. Optionally, the map 112 may include position information relative to other strokes and alternative strokes in shape (font) and order. Further, the map 112 may accommodate one or multiple stroke orders for a given character. The map 112 may further indicate, for the strokes of a given character, the appropriate one of various predetermined stroke categories containing those strokes.

In FIG. 1C, ref. 154 shows an exemplary Chinese character and ref. 155 shows its constituent strokes. In this example, the character of 154 is listed in the character vocabulary 111 and the constituent strokes 155 are listed in the map 112 in association with the character. In this example, the map 112 may also include one or more stroke orders, specifying an order of entering the strokes 155.

In similar fashion, the map 113 (FIG. 1B) includes a cross-reference between each character and a phonetic representation, that is, phonetic symbols, ruby characters, or other written symbols representing pronunciation of the given character according to a recognized system such as Bopomofo, Pinyin, etc. In the illustrated example, the phonetic representations of the map 113 include the appropriate tone(s) in addition to the phonetic symbol(s). FIG. 1C illustrates a representation of a sample traditional Chinese character (156) and its representation according to Bopomofo symbol (157) and tone representation (159).

As an alternative to the setup 100, applications with sufficiently large storage 108 may omit the character vocabulary 111. In this embodiment, each phrase in the vocabulary 110 is broken down directly into constituent strokes (112) and phonetic information (113). In applications with reduced storage or processing capacity, the phrase vocabulary 110 may be eliminated, in which case recognition of user input is limited to the character level and below.

Processor

Referring to FIG. 1A, one example of the processor 106 is a digital data processing entity of the type utilized in PDAs. However, in a more general sense, the function of the processor 106 may be implemented by one or more hardware devices, software devices, a portion of one or more hardware or software devices, or a combination of the foregoing without limitation. The makeup of some illustrative subcomponents is described in greater detail below, with reference to an exemplary digital data processing apparatus, logic circuit, and storage medium.

### Exemplary Digital Data Processing Apparatus

As mentioned above, data processing entities (such as the processor 106) may be implemented in various forms.

Some examples include a general purpose processor, digital signal processor (DSP), application specific integrated circuit (ASIC), field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

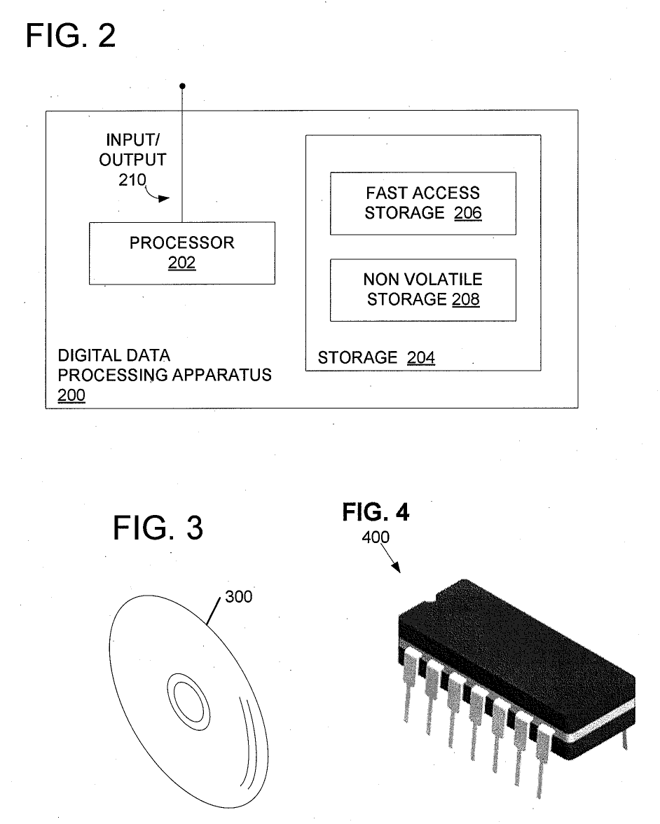

As a more specific example, FIG. 2 shows a digital data processing apparatus 200. The apparatus 200 includes a processor 202, such as a microprocessor, personal computer, workstation, controller, microcontroller, state machine, or other processing machine, coupled to digital data storage 204. In the present example, the storage 204 includes a fast-access storage 206, as well as nonvolatile storage 208. The fast-access storage 206 may be used, for example, to store the programming instructions executed by the processor 202. The storage 206 and 208 may be implemented by various devices, such as those discussed (below) in greater detail in conjunction with FIGS. 3 and 4. Many alternatives are possible. For instance, one of the components 206, 208 may be eliminated; furthermore, the storage 204, 206, and/or 208 may be provided on-board the processor 202, or even provided externally to the apparatus 200.

The apparatus 200 also includes an input/output 210, such as a connector, line, bus, cable, buffer, electromagnetic link, network, modem, or other means for the processor 202 to exchange data with other hardware external to the apparatus 200.

### Storage Media

As mentioned above, various instances of digital data storage may be used, for example, to provide storage 108 used by the system 100 (FIG. 1), to embody the storage 206 and/or 208 (FIG. 2), etc. Depending upon its application, this digital data storage may be used for various functions, such as storing data, or to store machine-readable instructions. These instructions may themselves aid in carrying out various processing functions, or they may serve to install a software program upon a computer, where such software program is then executable to perform other functions related to this disclosure.

In any case, the storage media may be implemented by nearly any mechanism to digitally storage machine-readable signals. One example is optical storage such as CD-ROM, WORM, DVD, digital optical tape, disk storage 300 (FIG. 3), or other optical storage. Another example is direct access storage, such as a conventional “hard drive”, redundant array of inexpensive disks (“RAID”), or another direct access storage device (“DASD”). Another example is serial-access storage such as magnetic or optical tape. Still other examples of digital data storage include electronic memory such as ROM, EPROM, flash PROM, EEPROM, memory registers, battery backed-up RAM, etc.

An exemplary storage medium is coupled to a processor so the processor can read information from, and write information to, the storage medium. In the alternative, the storage medium may be integral to the processor. In another example, the processor and the storage medium may reside in an ASIC or other integrated circuit.

### Logic Circuitry

In contrast to storage media that contain machine-executable instructions (as described above), a different embodiment uses logic circuitry to implement processing features of the system 100, such as the features performed by the processor 106.

Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

FIG. 4 shows an example of logic circuitry in the form of an integrated circuit 400.

### Operation

Having described the structural features of the present disclosure, the operational aspect of the disclosure will now be described. The steps of any method, process, or algorithm described in connection with the embodiments disclosed herein may be embodied directly in hardware, in a software module executed by hardware, or in a combination of the two.

### Overall Sequence of Operation

Introduction

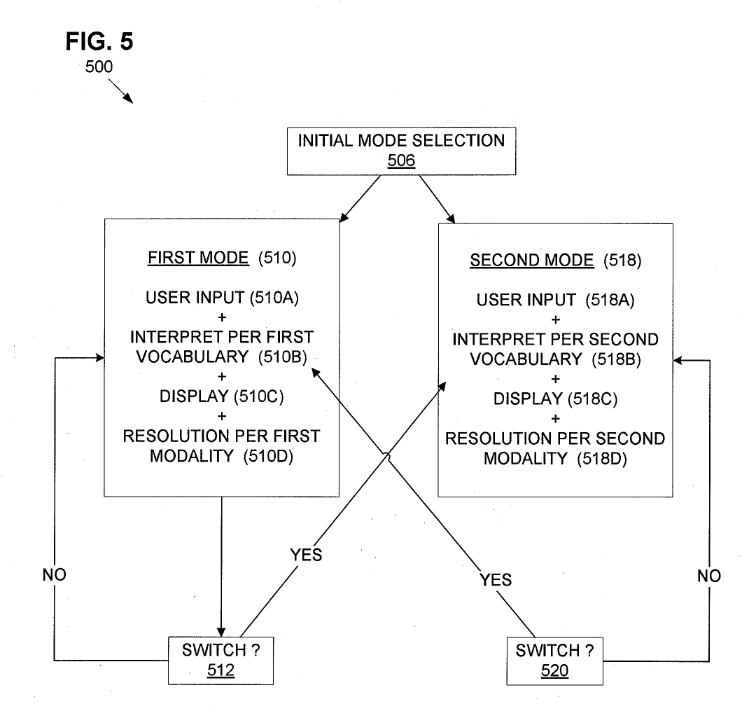

FIG. 5 shows a sequence 500 to illustrate one example of the method aspect of this disclosure. Broadly, this sequence interprets user entered text under different operating modes. Each mode uses a different vocabulary, and may additionally include a different modality for ultimately resolving and completing the input. For ease of explanation, but without any intended limitation, the example of FIG. 5 is described in the specific context of the system 100 of FIG. 1 as described above.

In the following description, the system 100 operates according to two predefined “modes.” Of course, there may be three or more modes, but two are discussed here to provide an easily understood example.

In one implementation, each “mode” is an operational sequence in which the user enters text and the system 100 interprets and presents a representative output according to a specific one of the vocabularies 180-182. Accordingly, one aspect of this mode is the view presented to the user.

In a different implementation, the system 100 simultaneously interprets user entered text according to both vocabularies 180-182, and each “mode” concerns the presentation to the user of one of these interpretations or another. In one sense, this is analogous to different views of a database query or large dataset.

In either implementation (i.e., “on demand” or simultaneous interpretation of user input according to multiple vocabularies), the currently selected mode includes presentation details such as prompting, feedback, interpretation, menus, and other user features appropriate to the vocabulary 180-182 associated with that mode.

Optionally, the different modes utilize different modalities (described below) for user completion of entered text.

In one example, used throughout this disclosure, a first mode is used to enter logographic characters (such as Chinese characters), and a second mode is used to enter alphanumeric text of an Indo-European language (such as English text).

The notion of “logographic” characters herein is used without limitation, and includes Chinese pictograms, Chinese logograms proper, Chinese indicatives, Chinese sound-shape compounds (phonologograms), Japanese characters (Kanji), Korean characters (Hanja), etc. Furthermore, the system 100 may be implemented to a particular standard, such as traditional Chinese characters, simplified Chinese characters, or another standard, or to a particular font, such as Chinese Song. And, although the term “logographic” is used in these examples, this is used without any intended limitation and shall include a variety of many different logographic, ideographic, pictographic, lexigraphic, morpho-syllabic, or other such writing systems that use characters to represent individual words, concepts, syllables, morphemes, etc. Similarly, “alphanumeric” characters is used herein without limitation, including Latin and other Indo-European letters, numeric digits, spaces and punctuation, and other symbols part of common electronic character sets and/or those used in text-based communications.

Mode Selection

Step 506 sets the system 100 to operate in one or the other predefined operating modes. This may be achieved in different ways. Operating mode, for example, may be established according to a system-defined or user-defined default setting whenever the system 100 is powered-up, re-booted, configured, installed, refreshed, upgraded, or other such event. As a different example, the system 100 may require the user to select the initial operating mode whenever the system 100 is powered-up, re-booted, configured, installed, refreshed, upgraded, or when a new user entry is begun, switch between application program, etc. One example is where the user configures a mobile phone's menus to display Traditional Chinese, so step 506 sets the corresponding initial operating mode to Traditional Chinese using BoPoMoFo phonetic input by default. As a different example, the system 100 may self-determine operating mode based on context. For example, step 506 may sense that the current input field is for entry of a Web site URL and respond by prohibiting selection of a logographic character set.

After step 506, one of steps 510 or 518 is performed. Namely, step 510 is performed if the first operating mode is has been selected (from 506), and step 518 is performed if the second operating mode has been selected.

First Mode

Step 510a begins by receiving entry of user input via the data entry tool 104. This user input includes key selections specifying intended text. In the present example, text in the first mode comprises words made of alphabetic characters, and Indo-European words in a more particular embodiment, and English words in a still more particular embodiment. In this same example, text in the second mode (described below) comprises logographic characters. Therefore, “text” is used broadly to encompass a broad variety of written communications.

The meaning of the user input is ambiguous in that each key (of the data entry tool 104) simultaneously represents multiple symbols according to the first mapping 176a. Each symbol comprises at least one alphabetic letter, numeric digit, symbol, character, some other sub-word component, or combination of one or more of the foregoing or another text subcomponent. In the presently illustrated example and mode, the keys' symbols are alphabetic letters and numbers as shown in Table 1. In implementations of the data entry tool 104 utilizing a telephone keypad, and using the mapping 176a and Table 1, entry of a number two key (without more) is ambiguous because it might represent different symbols such as a numeral two or any of the letters “a” or “b” or “c.”

Also occurring in step 510a, the processor 106 stores the raw (ambiguous) user input in the input buffer 170. In addition, the processor 106 in step 510b interprets the raw user input (now stored in the buffer 170) according to the first vocabulary 180. In the first operating mode, the system 100 displays (510c) interpretations of user input according to the first vocabulary 180 yielding multiple candidates possibly formed by the user input. Each candidate in this example includes one or more English words.

Of course, the user input (510a) and interpretation (510b) and display (510c) operations may be performed repeatedly within step 510. In this regard, the system continually updates the interpretation of user input (510b) so far to account for newly received input (510a).

In addition to steps 510a-510b, the first mode 510 provides a first modality (510d) for user-driven resolution of ambiguity of the user input to specify desired text according to the first vocabulary 180. Chiefly, the user input is interpreted (510b) as direct entry of an alphanumeric string, where the first modality 510d comprises user selection of one of the displayed candidates. In one example, the operation 510d may flush the buffer 170 responsive to an appropriate event, such as user selection of the intended text or other act completing resolution of user input.

Various examples of Indo-European text entry are described in the following U.S. patent documents, each of which is incorporated by reference in its entirety: U.S. Pat. No. 5,818,437, U.S. Pat. No. 6,011,554, U.S. Pat. No. 6,286,064, U.S. Pat. No. 6,801,190, and U.S. Publication No. 2002/0196163.

Second Mode

In the illustrated example, the second mode 518 concerns user entry of logographic characters. As with step 510, the system 100 begins in step 518 by receiving user input via the data entry tool 104 (step 518a). More particularly, the user submits input via keyboard, where this input specifies an intended text string. This may be input using strokes, stroke categories, or phonetic spelling of a desired logographic character. In the case of phonetic spelling, the meaning of the user input will be ambiguous if this employs the mapping 176a or similar mapping, where keys can represent multiple different symbols. Even with stroke (or stroke category) entry, the input will be ambiguous in many cases because a certain stroke (or stroke category) sequence may be common to multiple logographic characters.

Each symbol, in the present example, comprises a feature that is relevant to identifying contents of the second vocabulary 182, with some examples including at least one alphabetic letter, numeric digit, symbol, character, some other sub-word component, or combination of one or more of the foregoing. Further examples may include strokes, syllables, and/or affixes/roots from various languages and others such as kana, jamos, etc.

Also occurring in step 518a, the processor 106 stores the user input in the input buffer 170. In one example, this involves storing a raw indication of which key the user pressed, without any interpretation or meaning.

Also occurring in the second mode 518, the processor 106 interprets the user input (stored in the buffer 170) according to the second vocabulary 182 (step 518b). In the second mode, then, the system 100 displays (518c) interpretations of user input according to the second vocabulary 182 yielding any candidates possibly formed by the user input. Each candidate includes one or more logographic characters in this example. The foregoing operation considers what the keys of the data entry tool 104 represent, according to the mapping 176b as discussed above.

The user input (518a) and interpretation (518b) and display (510c) operations may be performed repeatedly within step 518. In this regard, the system continually updates the interpretation of user input (518b) so far to account for newly received input (518a). Various approaches for entry and interpretation of user input of logographic language characters are discussed in the following U.S. patent documents, incorporated herein by reference: U.S. Pat. No. 5,187,480, U.S. Publication 2004/0239534, U.S. Publication 2005/0027524, U.S. Pat. No. 6,646,573, U.S. Pat. No. 5,945,928.

Step 518 also assists the user in resolving the intended text input, which occurs in step 518d. This performed according to a second modality, as part of the second mode. In other words, step 518 provides a second modality for user-driven resolution of ambiguity of the user input to specify desired text according to the second vocabulary 182. The modality of input resolution refers to the manner in which the system 100 displays alternative text interpretations to the user, and offers options to the user for ultimately communicating to the system 100 which text input was specifically intended. As one example of a modality for resolving intended text input, the system 100 may require two or more input steps: entry of the phonetic spelling of the syllable or phrase followed by “conversion” and/or selection of the intended logographic character(s). A more specific example of this modality is discussed in U.S. Publication No. 2005/0027524, referenced above. In a different example, the system 100 allows entry and selection of a word in a single step. A system with a “direct display” feature, for example, offers the logographic character equivalent of the input sequence, rather than the phonetic or stroke interpretation, as the default selection, or places it provisionally at the text insertion point. Another example is discussed in U.S. Pat. No. 6,646,573, mentioned above.

As with the operation 510, the operation 518d may flush the buffer 170 responsive to an appropriate event, such as user selection of the intended text or other act completing resolution of user input.

As mentioned above, the first mode is used to enter logographic characters, such as Chinese characters. This may involve the entry of single characters, character subcomponents, or phrases comprised of multiple characters. For ease of explanation, the current example illustrates user entry of single characters.

Further discussing the entry of logographic characters (518a), this may be carried out in various ways. For example, in second mode the user may enter text using the phonetic spelling of logographic language characters, such as Pinyin, BoPoMoFo, Jianpin, kana, or another or phonetically based text input. In this case, the second mode may employ the same or substantially similar mapping as 176a. In other words, a typical Indo-European mapping of alphabetic letters to telephone keys may apply, e.g., numeral two representing “a” and “b” and “c.”

As an alternative to the foregoing example, the entry of logographic characters (518a) may involve user entry of strokes or stroke categories to define a character. Here, the mapping 176b correlates different strokes and/or stroke categories to the keypad keys of the input tool 102. In this mode, the system 100 displays one or more phonetic or stroke interpretations of the user input, and processes user input selecting of one of these interpretations (518d). The system may further display one or more candidates for user selection, such as one or more logographic characters and each corresponding to one of the one or more phonetic or stroke interpretations of the user input. In one example, the system displays only the Chinese characters and/or phrases that serve to interpret the user input, whereas in another example the system additionally shows the phonetic or stroke interpretations and the corresponding Chinese characters and/or phrases.

Various examples, extensions, and variants of the foregoing are described in the following U.S. patent documents, each of which is incorporated by reference in its entirety: (1) U.S. Publication 2005/0027524 A1, published Feb. 3, 2005 and entitled “System and Method for Disambiguating Phonetic Input”, and (2) U.S. Publication 2005/0027534 A1, published Feb. 3, 2005 and entitled “Phonetic and Stroke Input Methods of Chinese Characters and Phrases.”

Switch 512, 520

Steps 512 and 520 are performed after steps 510 and 518, respectively. In steps 512 and 520, the system 100 asks whether something has triggered a switch between the operating modes 510, 518. Depending upon the desired implementation, this may be triggered by an event or user input.

User input may be conveyed by different input mechanisms. One example is where the user presses a keyboard button that is dedicated for this purpose, or presses a general purpose button or button sequence. As another example, the user operates or responds to a graphical user interface feature such as icon, pull-down menu, toggle switch, or other user-selectable mechanism for receiving user instructions to switch operating modes. For example, the system 100 may present a toggle icon that is user-selectable to change operating modes. Another example is where user operation of the user interface feature is triggered when the user activates a keyboard button or graphical user interface with an act that exceeds a given maximum time (such as holding the button or pausing on the graphical user interface).

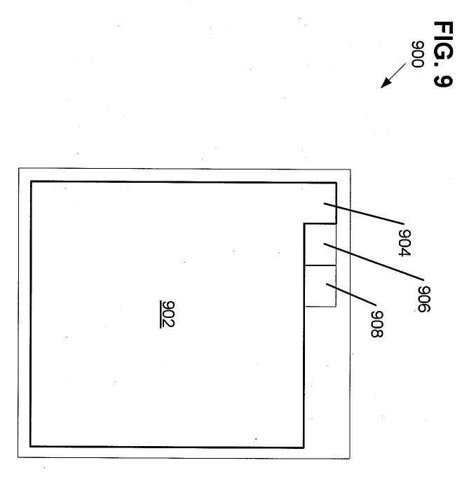

In another example, the display 102 includes a series of tabs, each tab representing a different corresponding one of the vocabularies 180, 182 (and modes 510, 518); responsive to user selection of one of the tabs, the system presents all interpretations made according to the corresponding vocabulary. FIG. 9 shows an illustration of this. Here, the display 900 includes various pages (such as 902), where the display of each page occurs responsive to user selection of that page's tab. The tabs are illustrated at 904-908. In the example 900, the page 902 and its tab 904 are displayed, with other pages (associated with the tabs 906, 908) are hidden.

In a specific example, user operation of this switch 512, 520 function may be achieved by a single user-performed action, such as a single click, button press, utterance, or other input.

In a different example, aside from user input, the switch 512 may be event-driven. For example, the processor 106 may switch operating modes automatically in response to the comparative availability of candidates (for example, when the input sequence matches no or few candidates when interpreted in the first mode but one or many candidates when interpreted in the second mode). Another example of an event-driven mode switch may occur in response to the application program being used, for example, instant messaging versus word processing. Still another example of an event is the context within an application, for example, one or more participants in a chat room writing something in the language of the non-selected operating mode.

If switch is dictated (512, 520) when operating in the first mode 510, then the program 500 advances to step 518 to begin operating in the second mode instead of the first mode. The switch 520 from second 518 to first operating mode 510 is conducted in a similar manner. Thus, the system 100 engages exclusively in one or another of the modes (510, 518) in response to user operation of a user interface feature, or occurrence of an event, causing a switch between the modes.

When a switch occurs, as in 512 or 520, the processor 106 re-interprets the existing user input stored in the input buffer 170 according to the switched-to operating mode. In other words, the switching operation 520 jumps to step 510b, and the switching operation 512 jumps to step 518b. No additional user input is needed, although the newly selected mode 510 or 518 now accepts additional user input (by repeating step 510a/518a) and interprets the aggregate input (by repeating step 510b/518b) as needed. Therefore, it is convenient for the user to switch between interpretations of the user input vocabulary according to different vocabularies.

### Alternate Embodiment as to Interpretation

In a different embodiment, the interpretation acts (510b, 518b) are conducted simultaneously. Here, step 510b also includes performance of step 518b, and vice versa. Therefore, when a switch (512, 520) occurs, the switched-to mode can begin more quickly since the user input has already been interpreted, at least partially. In this embodiment, one difference between the operating modes 510, 518 is still the presentation of different information the user (510d, 518d), and namely, presentation of output candidates according to one vocabulary 180 or the other 182. Another difference, optionally, is that the modes 510, 518 may employ different modalities (510d, 518d) for ultimately resolving user input.

### Broad Applicability to Languages, Dialects, Etc.

In the foregoing description, and numerous examples given in this disclosure, a first mode is used to enter alphanumeric text of an Indo-European language (such as English) and a second mode is used to enter logographic characters (such as Chinese characters). This is merely one embodiment of the present disclosure, however.

There is no requirement that either mode include logographic characters, and no requirement that either mode include Indo-European text. In a different embodiment than that detailed above, both modes correspond to languages with the same or substantially similar alphabets, such as Spanish and English, or Spanish and French. In this embodiment, the mappings 176a-176b may be the same or combined into one. In another embodiment, one mode may utilize English, with the other mode using Hindi. The Hindi mode may, for example, transliterate Hindi words using Latin characters and display the words in Hindi script. Accordingly, each mode may employ any desired language, dialect, alphabet, or other scheme.

And, aside from languages, the vocabularies may be implemented to specify different listings of recognized words, phrases, characters, radicals, or other linguistic components of a language, dialect, sociolect, jargon, etc. Vocabularies may also pertain to a language subset, such as English acronyms, English proper nouns, Chinese acronyms, or another subset.

Furthermore, operation 500 of the system may further include another operating mode where user entry is unambiguously interpreted according to a mapping (e.g., Table 1) of keypad keys to numbers.

Furthermore, although this disclosure has illustrated certain examples using two operating modes, the system may include a multiplicity of operating modes. In one example, the system provides operating modes corresponding to the following vocabularies: English words, Chinese characters and/or phrases, Chinese acronyms, and unambiguous numerical entry.

### Application

There are various applications for a system such as that disclosed herein, which interprets user entered text under different vocabularies corresponding to different modes, where each mode presents a different output interpretation of user entered text, and may additionally include a different modality for ultimately resolving and completing the input. Without any intended limitation, some exemplary applications are given as follows.

In one case, a bilingual user has become comfortable entering text using the first mode (510) and second mode (512). Thus, the user becomes accustomed to performing key input sequences regardless of the currently selected mode. Upon completion of the key input sequence, the user selects the proper mode (if not already selected) to interpret the key sequence according to the desired mode.

In another example, a user inadvertently failed to change the operating mode from the initial selection (506). Then, the user entered a key input sequence while in the wrong mode. Here, the user's effort in entering text is not wasted, since the user can switch to the other mode while retaining the key input sequence so far.

In another example, the processor 106 is programmed to automatically return to a given one of the modes 510/518 after each item of text is entered and resolved. This may be a convenient approach for users employ text of their home language almost exclusively, but have reason to enter text in another language on occasion. Here, the user begins entering text in the second language, and the system automatically reverts to the home language after entry of a single word in the alternate language. If the user forgets about the automatic reversion, s/he may enter text in the home language while intending to continue entering more words or characters in the alternate language.

The following examples explore these and other applications in greater detail.

### FIRST EXAMPLE

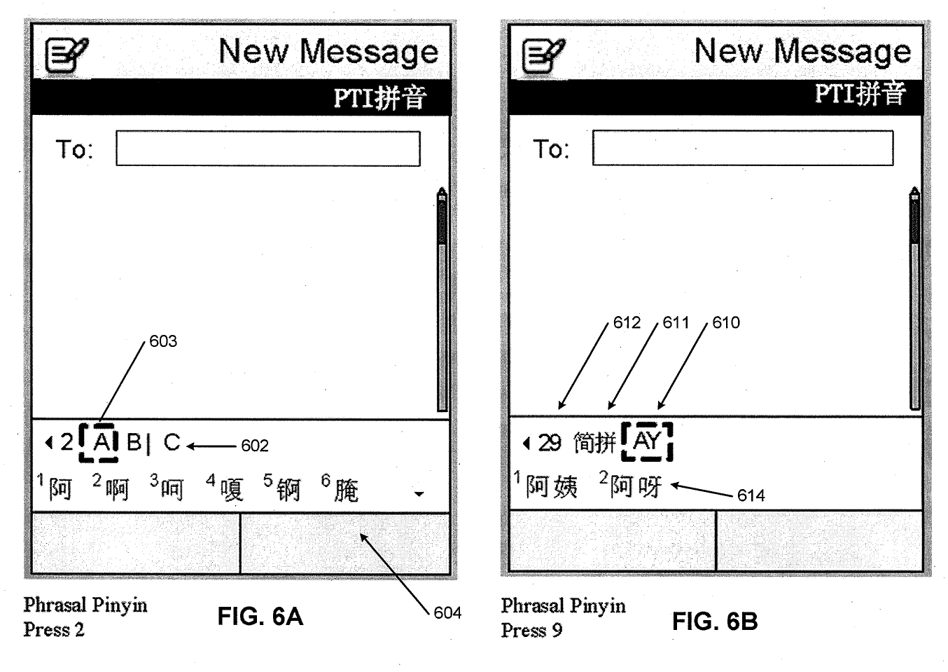

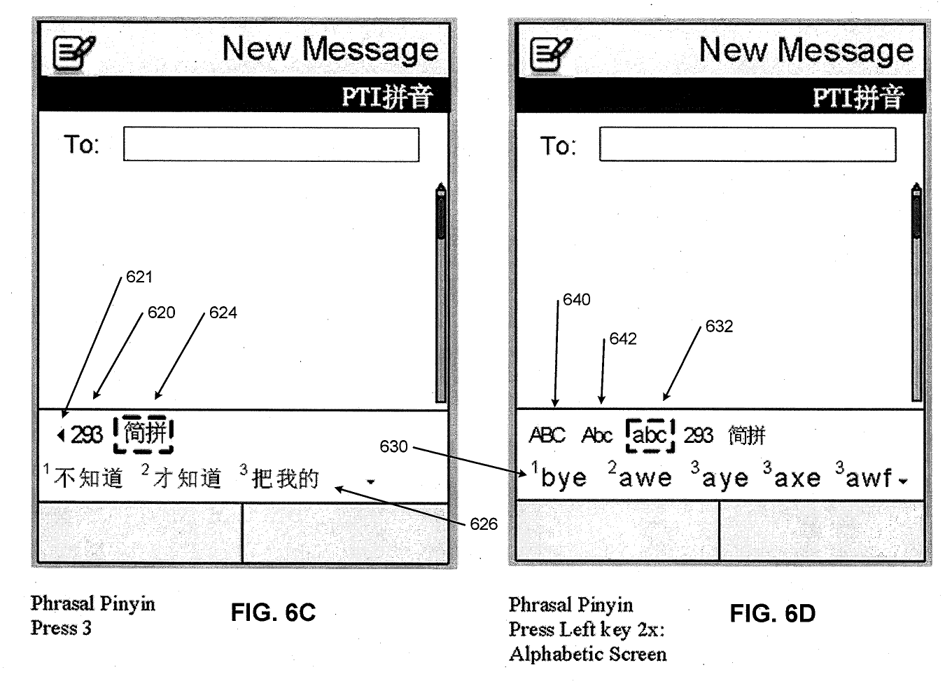

### FIGS. 6A-6D

With reference to FIG. 5 along with FIGS. 6A-6D, a more specific example of the operating sequence 500 is described.

The following is an overview of FIGS. 6A-6D. In this example, there are multiple vocabularies, these corresponding to English words, English proper nouns, English acronyms, Chinese characters and phrases, and Chinese acronyms. The system uses an intermediate vocabulary (not shown) to resolve user input of phrasal Chinese (namely, Pinyin), which is used to specify intended Chinese characters. The system 100 is configured such that the second mode (518) operates to receive the user's entry of Chinese characters by submitting Pinyin text via telephone keypad entries. Here, the initial mode selection 506 occurs when the system 100 is turned on, and operates to initially select Pinyin (i.e., the second mode 518). As described below, the user is pressing the key sequence “293” one key at a time in order to type “bye” in English. But in the default mode, the system is (also) matching the input as if the user is typing Pinyin. Upon the third key press, there are no possible Pinyin spellings remaining, but some acronyms match, so an acronym “placeholder” becomes the remaining (default) selection. This is described in greater detail as follows.

In step 518a, the system 100 detects that the user has pressed the “2” key. FIG. 6A shows the resultant screen shot after this operation. The “2” key may be interpreted as the numeral “2” or the Pinyin “A” or “B” or “C,” as shown by the items in the display line 602. In this view, the “A” is highlighted by user-operated cursor 603, causing corresponding Chinese characters having or beginning with this Pinyin pronunciation to appear along a display line 604. This is the interpretation (518b) of the user's input so far.

Continuing with the user input (518a), still in the default PinYin mode, the system 100 next detects that the user has pressed the “9” key. Although the “9” key may interpreted as “W” or “X” or “Y” or “Z,” the only valid Pinyin interpretation of the “2” plus “9” sequence (according to the currently implemented phrase database) is “AY.” Of course, this sequence may also be interpreted as the number “29.” FIG. 6B shows the resultant screen shot after this operation. In the screen of FIG. 6B, the possible interpretations of the user input so far are shown by the items 610-612. Item 610 shows the “AY” pronunciation, according to Pinyin. This is where the user-operated cursor resides, in the FIG. 6B screen shot. Placeholder 611 represents Chinese acronym interpretations of the user entry so far. Placeholder 612 represents the numerical interpretation of the user input so far, which is (unambiguously) twenty-nine. Display line 614 shows the two Chinese phrases corresponding to the Pinyin interpretation 610 (namely, the “AY” pronunciation).

Continuing with the user input (518a), the system 100 next detects that the user has pressed the “3” key. The system interprets the “3” entry as follows. This cannot be a further Pinyin entry, since there were no matching phrases (under the currently implemented phrase database), and no possible Pinyin spellings remaining after “AY” had been entered in FIG. 6B. However, this may be a numerical entry, as shown by the numeric placeholder “293” at 620 in FIG. 6C. Furthermore, the sequence “293” matched at least one Chinese acronym entry, so the Chinese acronym placeholder 624 (JianPin) is again displayed. When the acronym placeholder 624 is selected, various corresponding Chinese acronym interpretations appear on display line 626. In the present case, the user entry so far is “293,” and the display line 626 shows phrases that have acronyms corresponding to the user entry, namely “BZD” (Pinyin BuZhiDao), “CZD” (CaiZhiDao), and “BWD” (BaWoDe).

In step 520, the system 100 detects the user's command to switch into the second mode. In this example, the user effected the switch 520 by scrolling the cursor to the left twice (with respect to FIG. 6C), in order to highlight the “abc” placeholder 632 (as shown in FIG. 6D); that is, the “abc” placeholder (hidden in FIG. 6C) would be positioned just to the left of the placeholder “293” (620) in FIG. 6C as indicated by the left-arrow icon (621).

Now in the first mode 510, the system 100 interprets the same key sequence entered so far (namely, “293,” stored in the input buffer 170) according to the first vocabulary 180 rather than the second vocabulary 182. FIG. 6D shows the related screen shot. Appearing along the display line 630 are possible Indo-European (in this case, English) interpretations of the user-entry so far (namely, the sequence “293”), according to the second mode. In the embodiment illustrated here, there are two other placeholders, “ABC” (ref. 640) and “Abc” (ref. 642), which if selected would display in all-caps and initial-caps respectively the possible English interpretations of the user entry so far. Alternatively, the placeholders 640, 642 may present English Acronym and Proper noun interpretations (respectively) of the entry so far. In an alternate embodiment, an alphabetic placeholder is represented by the first alphabetic word that matches the input sequence (e.g., “bye”) rather than an icon or static text label such as 640-642 as illustrated.

### SECOND EXAMPLE

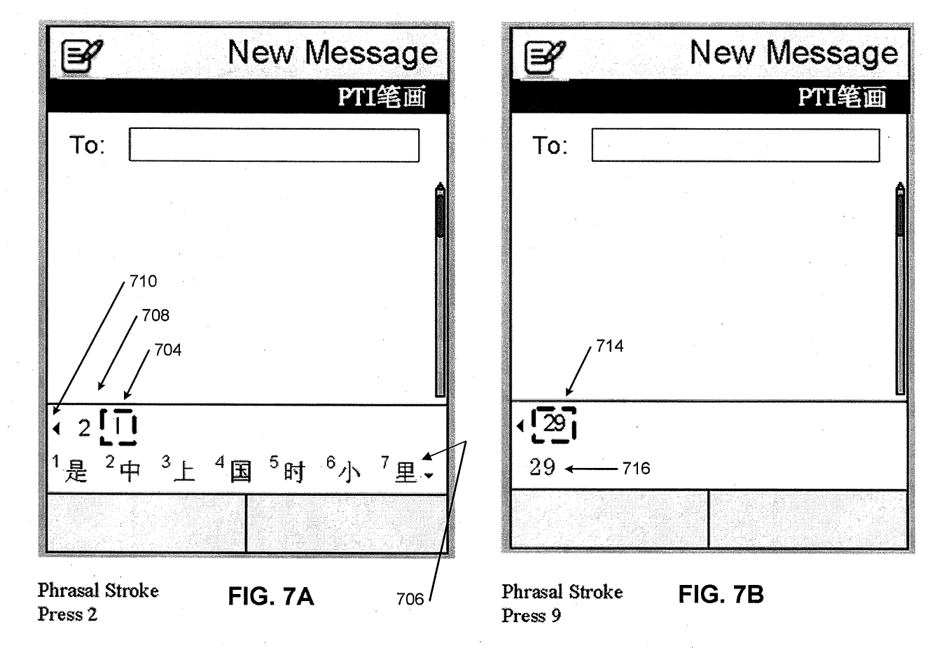

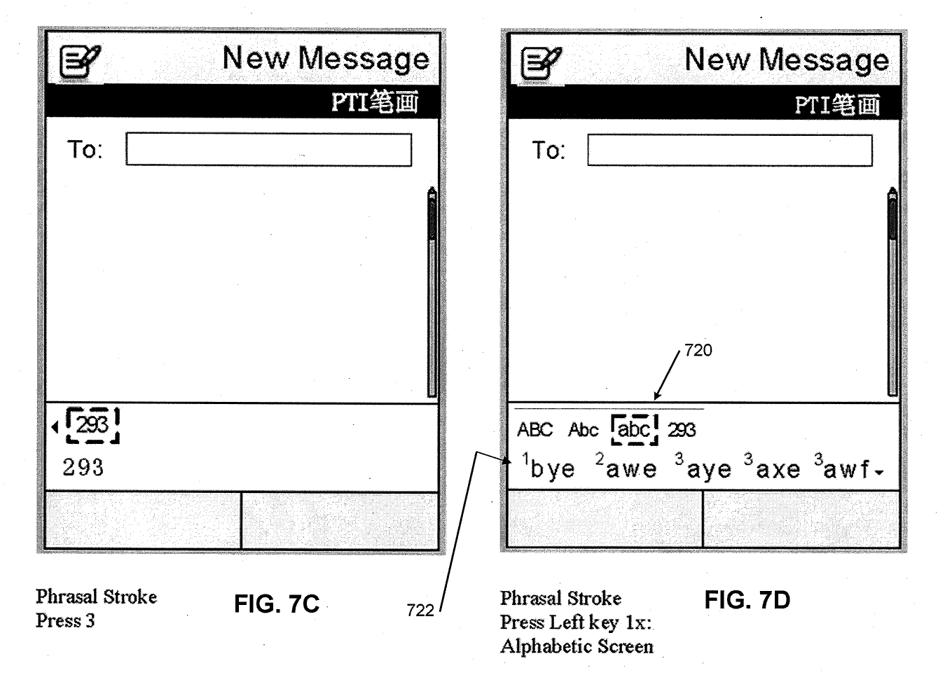

### FIGS. 7A-7D

With reference to FIG. 5 along with FIGS. 7A-7D, another example of the operating sequence 500 is described. Here, the system 100 is configured such that the second mode operates to receive the user's submission of character strokes via telephone keypad entries. The initial mode selection 506 occurs when the system 100 is turned on, and operates to initially select stroke input mode (i.e., the second mode, in this case). In this example, the user enters the keypad combination “293.”

In FIG. 7A the user enters “2.” According to the keypad-to-stroke mapping 176b in effect (namely, that of Table 2), there are various characters 702 that begin with the stroke category represented by key “2,” as shown in FIG. 7A. These appear at 706 when the stroke interpretation 704 is highlighted. Also shown in FIG. 7A is a placeholder 708 (not selected) which represents a numeric interpretation of user input. Not shown is another placeholder (not selected) for Indo-European interpretation of the user input (which represents a switch 520 to the first mode 510). This placeholder is available by scrolling to the left (as indicated by the arrow 710).

In FIG. 7B the user enters “9.” There are no valid stroke combinations corresponding to “29,” so the system 100 chooses the neighboring placeholder 714 as the default, and then displays the interpretation “29” on display line 716. This marks an automatic switch (520) to a third operating mode where user input is interpreted according to the unambiguous numerical meaning of the user keypad entry. At this point, the numeric interpretation appears on the lower line when the numeric placeholder is the (default) selection on the upper line. Like the “abc” and acronym placeholders, the numeric placeholder may be shown (at 714) as an icon or static text label (e.g. always “123”), but in the embodiment illustrated here the numeric placeholder echoes the input sequence so far. It demonstrates that there is always a valid interpretation (the numeric one) even if the current mode's vocabulary cannot offer one.

In FIG. 7C, the user enters “3.” The system continues with the numerical interpretation that began in FIG. 7B. In FIG. 7D, the user has scrolled to the left to select the “abc” placeholder 720. This triggers a switch from unambiguous numerical entry (a third mode, as discussed above) to the first mode. Now, the system displays the Indo-European interpretations of the input so far. These are shown in display line 722. The user may select “bye” by long-pressing “1,” or select “awe” by long-pressing “2,” etc. In other embodiments, the user may select an interpretation by chording, e.g., holding down an Alt key and then the number key associated with the desired interpretation.

### THIRD EXAMPLE

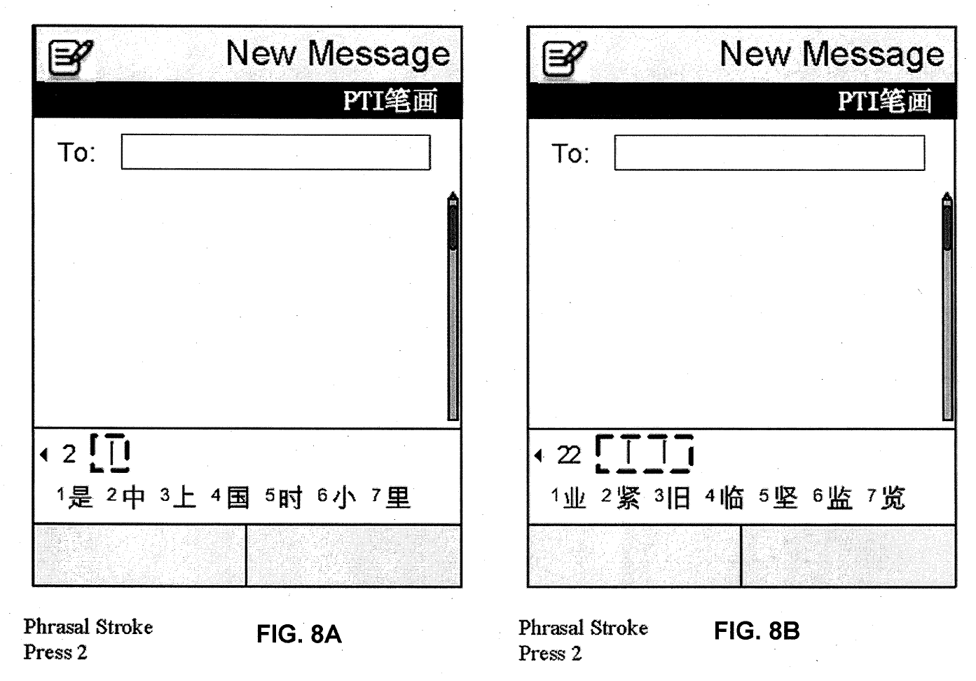

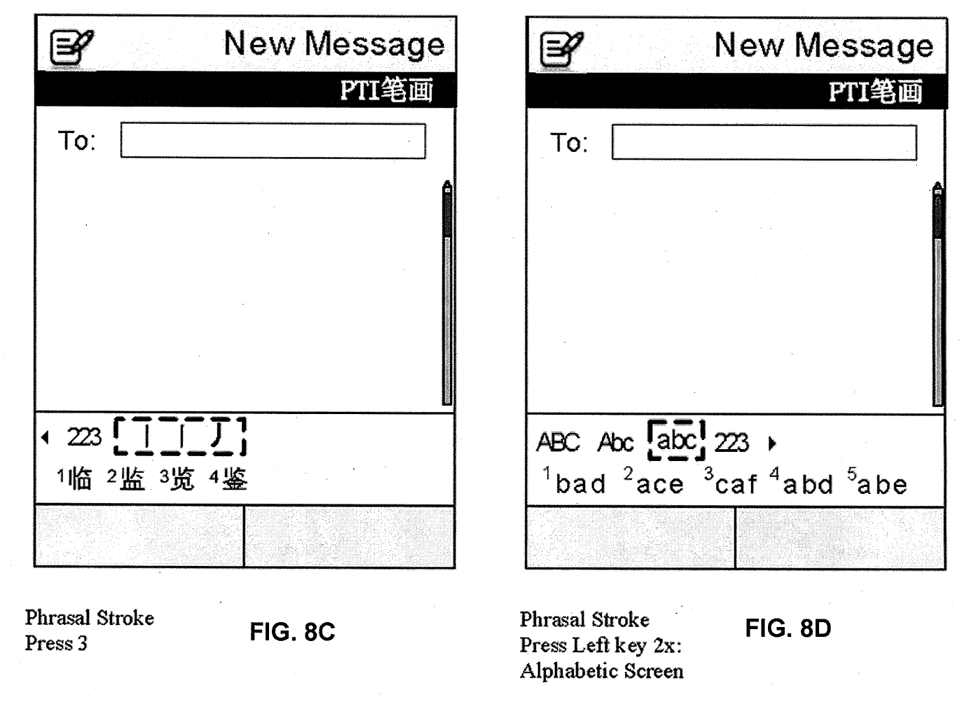

### FIGS. 8A-8D

With reference to FIG. 5 along with FIGS. 8A-8D, another example of the operating sequence 500 is described. Here, the system 100 is configured such that the second mode 520 operates to receive the user's submission of character strokes via telephone keypad entries. The initial mode selection 506 occurs when the system 100 is turned on, and operates to initially select stroke input mode (i.e., the second mode, in this case). In this example, the user enters the keypad combination “223” in FIGS. 8A-8C. Each key combination has a valid stroke interpretation, as shown by FIG. 8A (key “2”), FIG. 8B (input “22”), and FIG. 8C (input “223”).

However, the user had pressed the key sequence “223” one key at a time intending to type “bad” in English. But in the default mode, the system was matching the input as if the user is entering stroke inputs. Therefore, in FIG. 8D, the user changes the placeholder to “abc”, thereby effecting the switch operation 520. The system responds by displaying an English interpretation of the user entry so far (namely “223”). The user can select the desired word “bad” by long-pressing “1” or by equivalent means, such as tapping on the desired word directly with a stylus if the screen is touch-sensitive.

### Other Embodiments

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the present invention, and the scope of the present invention fully encompasses other embodiments which may become obvious to those skilled in the art, and that the scope of the present invention is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC 112, sixth paragraph, unless the element is expressly recited using the phrase “means for” or, in the case of a method claim, the phrase “step for.”

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer implemented text entry method comprising operations of:
receiving entry of user input via multi-key keyboard, said user input including key selections specifying intended text;
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
engaging exclusively in one or another of the modes in response to stimuli comprising: user instructions to switch between the modes.

2. The method of claim 1, the operations further comprising providing one or more further modes, each further mode displaying interpretations of the user input according to a further vocabulary yielding any entries of the further vocabulary specified by the user input.

3. The method of claim 2, each of the first, second, and further vocabularies selected from a list including:
phrases of logographic characters;
acronyms of logographic characters;
logographic characters;
words of an alphabet-based language or dialect;
proper nouns of an alphabet-based language or dialect;
acronyms of an alphabet-based language or dialect.

4. The method of claim 1,
further comprising:
providing a first mapping between the keys and a set of symbols for user specification of entries of the first vocabulary;
providing a second mapping between the keys and a second set of symbols for user specification of entries of the second vocabulary, where the second set of symbols is different than the first set of symbols;
where the first and second modes employ the first and second mappings, respectively, in performing the interpretations of the user input.

5. The method of claim 4, further comprising:
providing a third mapping between the keys and a set of numerals;
providing a third mode displaying a numerical interpretations of the user input according to the third mapping.

6. The method of claim 1, further comprising:
in each of the modes providing a different modality for user-driven resolution of user input to specify desired text according to the mode's respective vocabulary.

7. The method of claim 6, where
one modality comprises user selection of an intended word from a list of various words spelled-out by the key selections;
one modality comprises a selection of an intended logographic character from a list of logographic characters corresponding to user input of strokes or stroke categories or phonetic spelling.

8. The method of claim 1, where:
the first vocabulary comprises a set of words formed by components of an alphabet;
the second vocabulary comprises a set of logographic characters.

9. The method of claim 1, where the second vocabulary comprises a set of logographic characters, and in the second mode, user input is interpreted as one of the following: phonetic spelling of logographic characters, entry of strokes making up logographic characters, entry of stroke categories defining strokes of logographic characters.

10. The method of claim 1, where the second vocabulary corresponds to one of the following:
a dictionary of phonetic representations of logographic characters;
a dictionary of phonetic representations of logographic characters and logographic language phrases;
a dictionary of phonetic representations of logographic phrases;
a dictionary of constituent strokes or stroke categories of logographic characters.

11. The method of claim 1, where the user instructions to switch between the first and second modes are effected by a single user-performed action.

12. The method of claim 1, further comprising:
providing a graphical toggle icon for receiving said user instructions to switch between the first and second modes.

13. The method of claim 1, where the user instructions to switch between the first and second modes are effected during said user input specifying intended text when a duration of key selection exceeds a given length.

14. The method of claim 1, where:
the operations further comprise, irrespective of which mode has been engaged, providing a graphical user interface including multiple graphical placeholder icons including one placeholder icon associated with each of the modes;
receipt of user instructions to switch between the first and second modes occurs by way of placeholder icon selection.

15. The method of claim 14, further comprising:
responsive to interpretation of user input according to a given mode arriving at single vocabulary entry, replacing the graphical placeholder icon associated with the given mode with the single vocabulary entry.

16. The method of claim 1,
further comprising displaying a series of tabs, each tab representing a different one of the vocabularies;
where the user instructions to switch between the first and second modes are effected by user selection of a corresponding one of the tabs.

17. The method of claim 1, further comprising:
collecting the user input in a buffer;
responsive to user instructions to switch from a preceding mode to a subsequent mode, upon commencing the subsequent mode displaying interpretations of buffered user input.

18. The method of claim 1,
the operations further including providing a first mapping between the keys and letters of an alphabet, where some keys are mapped to multiple letters concurrently;
where entries of the first vocabulary comprise words formed by the alphabet, and interpretations of the user input according to the first vocabulary comprise words of the first vocabulary spelled-out by the user input according to the first mapping;
where entries of the second vocabulary comprise logographic characters, and the interpretations of the user input according to the second vocabulary comprise entries of the second vocabulary for which the user input specifies a pronunciation according to the first mapping and a prescribed alphabet-based phonetic input specification.

19. The method of claim 1,
where the operations further comprise providing a first mapping between the keys and letters of an alphabet, where some keys are assigned to multiple letters concurrently;
where entries of the first vocabulary comprise words formed by the alphabet, and interpretations of the user input according to the first vocabulary comprise words of the first vocabulary spelled-out by the user input according to the first mapping;
where the operations further comprise providing a second mapping between the keys and targets comprising strokes or stroke categories of logographic characters, where some keys are mapped to multiple targets;
where entries of the second vocabulary comprises logographic characters, and the interpretations of the user input according to the second vocabulary comprise entries of the second vocabulary for which the user input identifies constituent strokes.

20. A method of operating a computer to process user input entered via multi-key keyboard, where the user input includes key selections specifying intended text, the method comprising:
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
at any given time, limiting operation of the computer to a selected one of the modes, the selection defined according to stimuli comprising: user election as to mode.

21. A computer implemented text entry method comprising operations of:
receiving entry of user input via multi-key keyboard, said user input including key selections specifying intended text;
performing one or more of the following:
in a first mode, interpreting the user input according to a first vocabulary yielding any entries of the first vocabulary possibly specified by the user input;
in a second mode, interpreting the user input according to a second vocabulary yielding any entries of the second vocabulary possibly specified by the user input;
displaying one or another of the interpretations exclusively in accordance with stimuli including at least: user selection.

22. A computer implemented text entry method employing a multi-key keyboard, the method comprising operations of:
receiving entry of user input via multi-key keyboard, said user input including key selections specifying intended text;
providing a first mode, displaying interpretations of the user input according to an alphabet-based vocabulary and first mapping yielding any entries of the vocabulary spelled-out by the user input, the first mapping correlating the keys with letters of the alphabet;
providing a second mode, displaying interpretations of the user input according to a logographic character-based vocabulary yielding any entries of the character-based vocabulary possibly specified by the user input according to one of the following:
spelling-out phonetic representations of one or more logographic characters using the first mapping;
specifying a sequence of strokes or stroke categories defining one or more logographic characters under a second mapping correlating keys with strokes or stroke categories;
engaging exclusively in one or another of the modes in response to stimuli comprising: user instructions to switch between the modes.

23. A computer readable medium storing a program to perform operations for computer implemented text entry, the operations comprising:
receiving entry of user input via multi-key keyboard, said user input including key selections specifying intended text;
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
engaging exclusively in one or another of the modes in response to stimuli comprising: user instructions to switch between the modes.

24. A computer readable medium storing a program to operate a computer to process user input entered via multi-key keyboard, where the user input includes key selections specifying intended text, the program performing operations of:
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
at any given time, limiting operation of the computer to a selected one of the modes, the selection defined according to stimuli comprising: user election as to mode.

25. A computer readable medium storing a program for computer implemented text entry, the program performing operations of:
receiving entry of user input via multi-key keyboard, said user input including key selections specifying intended text;
performing one or more of the following:
in a first mode, interpreting the user input according to a first vocabulary yielding any entries of the first vocabulary possibly specified by the user input;
in a second mode, interpreting the user input according to a second vocabulary yielding any entries of the second vocabulary possibly specified by the user input;
displaying one or another of the interpretations exclusively in accordance with stimuli including at least: user selection.

26. A computer readable medium storing a first program to install a second program on a target computer, the second program being executable to perform operations for computer implemented text entry comprising:
receiving entry of user input via multi-key keyboard, said user input including key selections specifying intended text;
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
engaging exclusively in one or another of the modes in response to stimuli comprising: user instructions to switch between the modes.

27. A computer implemented text entry apparatus, comprising:
a data entry tool including a multi-key keyboard;
a display;
a processor programmed to perform operations comprising:
receiving entry of user input via the keyboard, said user input including key selections specifying intended text;
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
engaging exclusively in one or another of the modes in response to stimuli comprising: user instructions to switch between the modes.

28. A computer implemented text entry apparatus, comprising:
a data entry tool including a multi-key keyboard;
a display;
a processor programmed to perform operations comprising:
receiving entry of user input via the keyboard, said user input including key selections specifying intended text;
performing one or more of the following:
in a first mode, interpreting the user input according to a first vocabulary yielding any entries of the first vocabulary possibly specified by the user input;
in a second mode, interpreting the user input according to a second vocabulary yielding any entries of the second vocabulary possibly specified by the user input;
displaying one or another of the interpretations exclusively in accordance with stimuli including at least: user selection.

29. A computer implemented text entry apparatus, comprising:
data entry means for receiving user input via multiple keys;
display means for receiving a machine-readable signal and providing human-readable output;
processing means for performing digital data processing operations comprising:
receiving entry of user input via the data entry means, said user input including key selections specifying intended text;
providing a first mode, displaying interpretations of the user input according to a first vocabulary yielding any entries of the first vocabulary possibly specified by the user input;
providing a second mode, displaying interpretations of the user input according to a second vocabulary yielding any entries of the second vocabulary possibly specified by the user input;
engaging exclusively in one or another of the modes in response to stimuli comprising: user instructions to switch between the modes.

30. A computer implemented text entry apparatus, comprising:
data entry means for receiving user input via multiple keys;
display means for receiving a machine-readable signal and providing human-readable output;
processing means for performing digital data processing operations comprising:
receiving entry of user input via the keyboard, said user input including key selections specifying intended text;
performing one or more of the following:
in a first mode, interpreting the user input according to a first vocabulary yielding any entries of the first vocabulary possibly specified by the user input;
in a second mode, interpreting the user input according to a second vocabulary yielding any entries of the second vocabulary possibly specified by the user input;
displaying one or another of the interpretations exclusively in accordance with stimuli including at least: user selection.
